(19) United States
(12) Patent Application Publication
(10) Pub. No.: US 2008/0096557 A1
(43) Pub. Date: Apr. 24, 2008

(54) Efficient and dynamic identification of allocations in a wireless packet communication system

(75) Inventors: Mika P. Rinne, Espoo (FI); Lars E. Lindh, Helsingsfors (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/906,694

(22) Filed: Oct. 3, 2007

Related U.S. Application Data
(60) Provisional application No. 60/849,549, filed on Oct. 4, 2006.

(51) Int. Cl. H04Q 7/20

(52) U.S. Cl. 455/435.1

(57) ABSTRACT

An apparatus, such as a base station which may be an evolved Node-B, includes a wireless transmitter configurable to conduct communications with a plurality of user equipment located in a cell; and a user equipment identification module configurable to define a number of bits (m) of a cell-specific user equipment identifier that is a sequence of n bits, where m≦n and to inform the user equipment of the value of m in a downlink message. The number of bits (m) represents a mask value specifying how many bits of the cell-specific user equipment identifier are to be used in signaling exchanges, thereby conserving system bandwidth and reducing signaling load.

### CLAIM OF PRIORITY FROM COPENDING PROVISIONAL PATENT APPLICATION

This patent application claims priority under 35 U.S.C. §119(e) from Provisional Patent Application No. 60/849,549, filed Oct. 4, 2006, the disclosure of which is incorporated by reference herein in its entirety, including all Exhibits appended thereto.

### TECHNICAL FIELD

The exemplary and non-limiting embodiments of this invention relate generally to wireless communication systems, methods, devices and computer program products and, more specifically, relate to techniques to accomplish wireless communications, including packet data communication between user devices or equipment and a network element, such as a base station.

### BACKGROUND

The following abbreviations are herewith defined:

3GPP third generation partnership project

UTRA universal terrestrial radio access

UTRAN universal terrestrial radio access network

Node B base station

UE user equipment

HO handover

EUTRAN evolved UTRAN

eNB EUTRAN (evolved) Node B

PHY physical layer

LTE long term evolution

c-RNTI cell specific radio network temporary identity

DRX discontinuous reception

WLAN wireless local area network

UL uplink (UE to eNB)

DL downlink (eNB to UE)

CRC cyclic redundancy check

HSDPA high speed downlink packet access

RRC radio resource control

MAC medium access control

DRX discontinuous reception

A proposed communication system known as evolved UTRAN (E-UTRAN, also referred to as UTRAN-LTE) is currently under discussion within the 3GPP. The current working assumption is that the DL access technique will be OFDM, and the UL technique will be SC-FDMA.

One specification of interest to these and other issues related to the invention is 3GPP TS 36.300, V8.0.0 (2007-03), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8).

The E-UTRA will be based on short term shared packet allocations instead of dedicated channels. The signaling is assumed to be done on a sub-frame basis, so that the multi-user scheduling is done as efficiently as possible from the cell throughput point of view. In addition, the UE may have unique DRX periods where it does not need to receive every signaling instance of every sub-frame.

Contrary to other types of conventional solutions in WLAN, where packet access is performed on a datagram-level, E-UTRA allows more efficient frequency multiplexing of multiple UEs.

For fast signaling, the radio links between the eNB and the UE need to be identified uniquely within the scope of one cell. It has been agreed by 3GPP RAN2 that a c-RNTI of 16 bits will be allocated from the eNB to each UE for communications. The c-RNTI is allocated in the eNB locally to be valid within the cell served by that eNB. In the case of handover (HO) of a UE to a cell, or in the case of initial access by a UE to a cell, a new c-RNTI is allocated by the target eNB to that UE.

In the shared signaling channel the c-RNTI is expected to be used for indicating the resource allocations in the DL and UL for each active UE in that cell. However, the bit-field consumption of the c-RNTI is quite excessive, especially when taking into account the additional channel coding needed.

Thus, one basic problem that is presented is that the c-RNTI bit field consumes an excessive amount of radio resources in the shared signaling channel.

### SUMMARY OF THE EXEMPLARY EMBODIMENTS OF THIS INVENTION

The foregoing and other problems are overcome, and other benefits are realized by the use of the exemplary embodiments of this invention.

In a first aspect thereof the exemplary embodiments of this invention provide a method that includes reducing a signaling load between a user equipment and a base station by defining for use a number of bits (m) of a cell-specific user equipment identifier that is a sequence of n bits, where m≦n, and informing the user equipment of the value of m in a downlink signaling message.

In another aspect thereof the exemplary embodiments of this invention provide an apparatus that includes a wireless transmitter configurable to conduct communications with a plurality of user equipment located in a cell; and a user equipment identification module configurable to define a number of bits (m) of a cell-specific user equipment identifier that is a sequence of n bits, where m≦n and to inform the user equipment of the value of m in a downlink signaling message.

In a further aspect thereof the exemplary embodiments of this invention provide a method that includes receiving from a network element a c-RNTI value and a mask value that specifies a number of bits of the c-RNTI to be used for wireless link signaling exchanges with the network element; and using only the specified number of bits of the c-RNTI in subsequent signaling exchanges.

In yet another aspect thereof the exemplary embodiments of this invention provide an apparatus having a receiver configurable to receive from a network element a mask value that specifies a number of bits of a c-RNTI to be used for wireless link signaling exchanges with the network element; and a unit responsive to the mask value to thereafter use only the specified number of bits of the c-RNTI.

### BRIEF DESCRIPTION OF THE DRAWINGS

In the attached Drawing Figures:

FIG. 1 shows a simplified block diagram of various electronic devices that are suitable for use in practicing the exemplary embodiments of this invention.

FIG. 2 presents an example of various c-RNTI masking thresholds.

FIG. 3A is a signal flow diagram that illustrates c-RNTI reallocation.

FIG. 3B is a signal flow diagram that illustrates the signaling of the target cell c-RNTI and the Mask of the target cell to the UE.

FIGS. 4 and 5 are graphs that show c-RNTI Mask behavior in a micro cell model and in a macro cell model for a user behavioral model (under various load conditions where the load is purely defined as a function of number of served UEs), respectively.

FIG. 6 is a logic flow diagram that is descriptive of a method performed by the eNB of FIG. 1, and the operation of a computer program product executed by a data processor of the eNB, in accordance with the exemplary embodiments of this invention.

FIG. 7 is a logic flow diagram that is descriptive of a method performed by the UE of FIG. 1, and the operation of a computer program product executed by a data processor of the UE, in accordance with the exemplary embodiments of this invention.

### DETAILED DESCRIPTION

Before discussing in detail the exemplary embodiments of this invention, it is noted that one potential solution to the problems discussed above is to combine the c-RNTI with the user-specific CRC field. This approach would clearly reduce the number of bits that need to be transmitted for the c-RNTI. However, an undesirable consequence of this approach is that the usable combinations of the user-specific c-RNTI and the user-specific CRC would radically limit the effective c-RNTI space. This is true at least for the reason that the Hamming distance between adjacent code-words needs to be sufficiently large to guarantee a reasonably low failure rate of error detection. This particular approach is currently used in the HSDPA technology. A significant aspect of this approach is that it requires all of the signaling information targeted at a given UE be separately coded and protected by the user-specific CRC. However, this is not always desirable as there exist signaling proposals where the allocation information of several UEs are included in a common Information Element, where the allocation information for the several UEs would be channel coded together to form a joint-coded block.

Another potential solution to the problem discussed above is to permit joint coding, and to apply a user-specific allocation identification, while still using a common CRC. This type of solution targets having a shorter allocation identification than the actual c-RNTI. The use of this approach would grant an allocation identification separate from the c-RNTI, and somehow provide that those allocation identifications (ids) present in the same instance of the control signaling can be understood uniquely by all the UEs. One proposal is to use DRX cycles in order to arrange non-overlapping short ids. However, this approach has the drawback that for short allocation ids the eNB has to group its served UEs in a particular way and, thus, the eNB needs to perform group management of the UEs. In general, it is not believed to be possible to create orthogonal groups of UEs such that their allocations would not appear occasionally in the same signaling channel instances in a give sub-frame. This means that the eNB would need to frequently rearrange the UE groups and also the allocation ids granted to the UEs. Any such change of an allocation id requires signaling from the eNB to any UE whose allocation id is to be changed. As can be appreciated, the use of this approach would consume signaling bandwidth, and further will experience events where the allocation ids of several UEs need to be changed substantially simultaneously, resulting in an occurrence of signaling bursts. Further, as the allocation ids are crucial both in receiving and transmitting packets in the short term, any signaling error will have a dramatic impact to the behavior of the UE in reception, or in transmission or in both.

The exemplary embodiments of this invention provide a novel solution to the foregoing problems that does not suffer from the drawbacks inherent in the foregoing and other possible approaches.

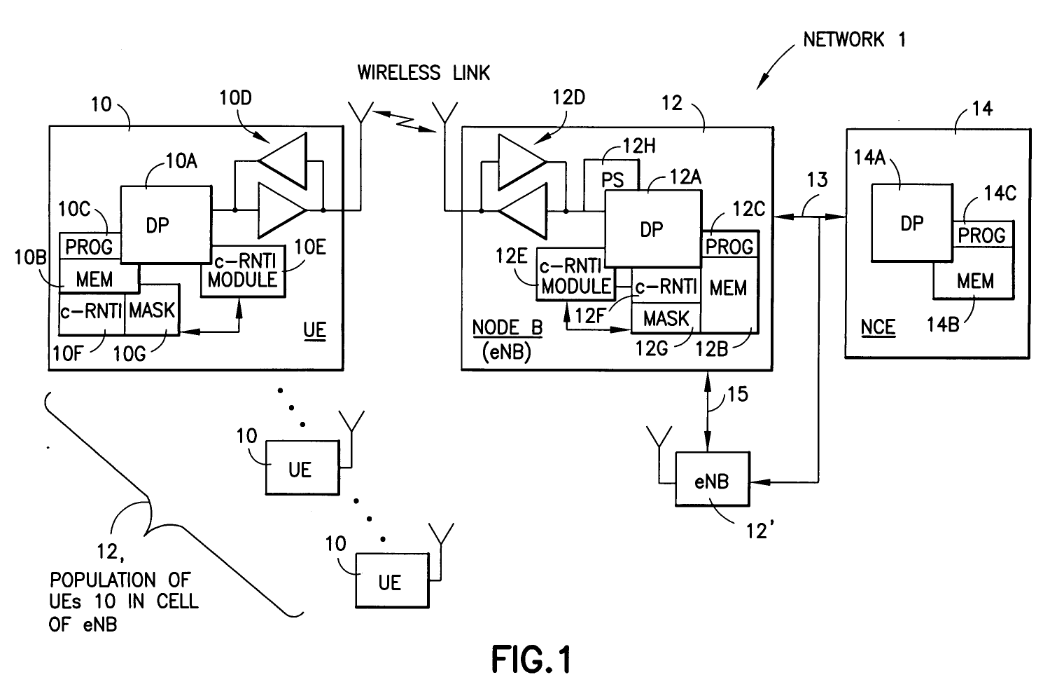

Reference is now made to FIG. 1 for illustrating a simplified block diagram of various electronic devices that are suitable for use in practicing the exemplary embodiments of this invention. In FIG. 1 a wireless network 1 is adapted for communication with a UE 10 via a Node B 12 (referred to interchangeably herein also as an eNB 12). The network 1 may include a network control element (NCE) 14 or a gateway to a further network e.g. the Internet. The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The Node B 12 is coupled via a data path 13 to the NCE 14 that also includes a DP 14A and a MEM 14B storing an associated PROG 14C. The PROGs 10C and 12C are assumed to include program instructions that, when executed by the associated DP, enable the electronic device to operate in accordance with the exemplary embodiments of this invention, as will be discussed below in greater detail.

That is, the exemplary embodiments of this invention may be implemented at least in part by computer software executable by the DP 10A of the UE 10 and by the DP 12A of the Node B 12, or by hardware, or by a combination of software and hardware.

In general, the various embodiments of the UE 10 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

Shown for completeness in FIG. 1 is a second eNB 12′, which may be assumed to be constructed and operated in the same manner as the eNB 12. An interface 15 exists between the eNBs 12 and 12′. This interface may the X2 interface, and the interface 13 may be the S1 interface, as defined in the above referenced 3GPP TS 36.300, V8.0.0 (2007-03), and in earlier versions thereof. During a handover event, such as when eNB 12 is the source eNB and the eNB 12′ is the target eNB, handover-related information can be passed between the eNBs 12 and 12′ over the X2 interface 15. Various handover-related aspects of the present invention are discussed in detail below.

By way of introduction, the exemplary embodiments of this invention do not use short ids as such, nor separate allocation ids as such. Instead, the exemplary embodiments of this invention use the full valid c-RNTI as granted to the UE 10, in conjunction with a parameter, referred to herein as a Mask, that defines how many least significant digits (bits) of the c-RNTI are actually used in the allocation signaling in the shared signaling channel. Thus, the mask is cell-common information.

The exemplary embodiments of this invention are based on a power of two law of the number of active UEs 10 present in the cell served by the eNB 12. Having knowledge of some number of UEs 10 active in the cell, and by reserving some address space for new entrants to the cell from initial access and HO, the eNB 12 allocates c-RNTIs below some given number of effective bits. This number of bits is then used during the actual signaling of allocations (where the given number of bits is less than or equal to the maximum-number of c-RNTI bits (e.g., 16 bits at present)). Once the number of bits to be used is defined, the eNB 12 creates the bit Mask to define how many bits of the c-RNTI are valid in the allocation signaling.

Once the number of UEs 10 served in a cell changes, the eNB 12 determines the proper size of the bit mask to apply and changes the bit mask value. This procedure does not have any impact on the c-RNTIs themselves, which are communicated but once to the UEs 10 and are thereafter available uniquely and reliably both in the eNB 12 and in the UE 10 (as granted during the access of the UE 10 to the cell). Thus, once the bit mask needs to be changed, it is very simple to do as it is common information for all the UEs served in that cell.

In FIG. 1 the UE 10 is shown as including a c-RNTI function or module 10E, as well as storage locations in the memory 10B for the UE-specific c-RNTI 10F and for the cell-specific Mask 10G. The eNB 12 is shown as including a c-RNTI function or module 12E, as well as storage locations in the memory 12B for a set of UE-specific c-RNTIs 12F corresponding to the population of UEs 10 in the cell of the eNB 12, and for the cell-specific Mask 12G. The c-RNTIs modules 10E and 12E are constructed and operated in accordance with the exemplary embodiments of this invention to apply and use the Masks 10G and 12G, respectively. For completeness, the eNB 12 is also shown as including a packet scheduler (PS) function or module 12H, as a feature of the E-UTRA system is that packet scheduling is done locally at the level of the eNBs 12, as opposed to be done at a higher level, such as at the NCE 14. Resource allocations for a specific UE 10 are associated with the UE's c-RNTI.

Signaling of the Mask 12G to the UEs 10 may be included in a shared signaling channel, or it may be included in System Information (SysInfo) signaling, as two non-limiting examples. If the Mask 12G is placed in the shared signaling channel it is frequently present but consumes only, for example, three to four bits, which is a favorable tradeoff considering the significantly larger number of c-RNTI bits that can be eliminated from the signaling channel by the use of the Mask 12G.

In a 16 bit-field a mask of, for example, three bits may assign many reasonable combinations of effective bits, e.g.:

Set={6, 8, 10, 12, 13, 14, 15, 16}

Set={6, 7, 8, 9, 10, 12, 14, 16}.

By coding what is implied that a given value of the n-bit Mask 12G corresponds to some predetermined number of effective c-RNTI bits. Using the first example given above, and assuming a 3-bit Mask 12G information element, one possible Mask 12G encoding may be:

| MASK | # of least significant c-RNTI bits to be used |
|---|---|
| 000 | 6 |
| 001 | 8 |
| 010 | 10 |
| 011 | 12 |
| 100 | 13 |
| 101 | 14 |
| 110 | 15 |
| 111 | 16 (use all c-RNTI bits) |

Note that Gray coding or some other suitable scheme could be used as well for the Mask 12G bits.

The coding of the sets of effective bits is uniquely decided and known to the eNB 12 and to the UEs 10. In a case of applying a 4-bit Mask 12G, all combinations of the bit-fields (out of 16) can be covered, even the non-practical ones.

An alternative signaling of the Mask 12G is to use the System Information message. All the UEs 10 that access a cell are required to decode relevant parts of the System Information, which may then contain the Mask 12G value that is in use in the cell. As such, the Mask 12G may be considered to be cell-specific common information.

For the HO situation, when the UE 10 receives the HANDOVER_COMMAND in the source or serving cell, it may obtain the c-RNTI granted to it by the eNB of the target cell. The HO-related signaling may then be modified to contain both the c-RNTI and the Mask 12G value that is in use in the target cell (which can differ from the Mask 12G value currently in use in the source cell).

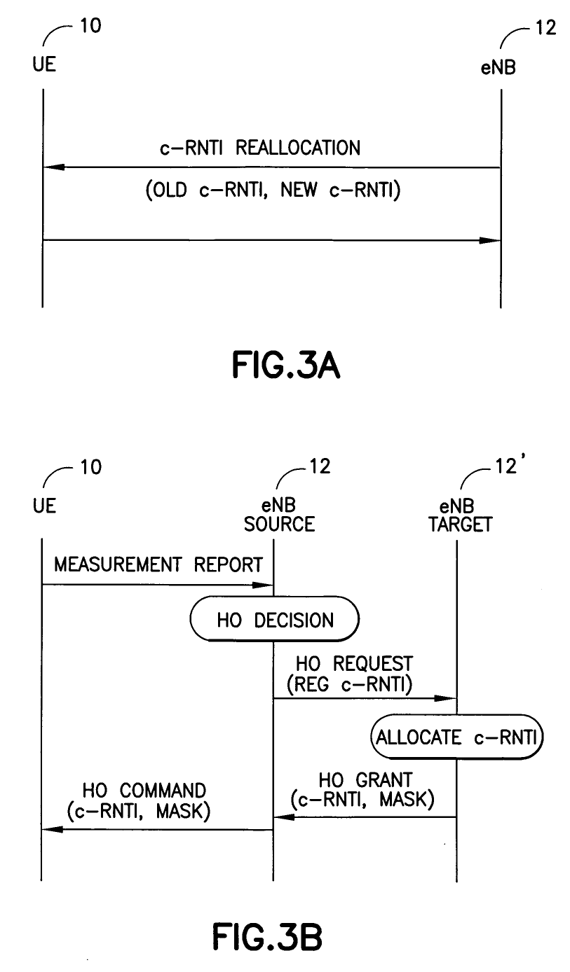

FIG. 3B is a signal flow diagram that illustrates the signaling of the target cell c-RNTI and the Mask 12G of the target cell to the UE 10. In FIG. 3B there is shown the UE 10 making a measurement report to the source eNB 12, which makes a HO decision. If the decision is made to handover the UE 10, the source eNB 12 sends a HO Request to a target eNB (referred to here as 12′, see also FIG. 1). In response, the target eNB 12′ allocates a c-RNTI to the UE 10, and replies with a HO Grant that includes the c-RNTI and, in accordance with exemplary embodiments of this invention, the Mask value 12G. The source eNB 12 then sends the HO Command message to the UE 10, where the HO Command message includes the allocated c-RNTI and the Mask value received from the target eNB 12′.

If the signaling of the Mask 12G is present in the System Information, there is a consequence that if the value of the Mask 12G changes, then all of the UEs 10 in the cell will have to read that particular System Information field to learn the new value of the Mask 12G. However, this type of procedure is already used for other purposes, where decoding of the System Information is avoided for a case where there are no changes. Once a change in the System Information occurs the UEs 10 are informed with a Notification, e.g., in the Master Information Block (MIB), or as a value tag in the System Information change indicator. After reception of such a change flag the UEs 10 decode the updated field(s) of the System Information elements and thereby obtain the new information, which may be the new value of the Mask 12G in this case.

Note that the use of the System Information may require that a change to the Mask 12G value be signaled well in advance, and that the timing of the change be given as well to synchronize the population of UEs 10 to the changed number of bits of resolution of the c_RNTI 10F, 12F. However, in the approach of providing the Mask 12G value in every instance of the shared signaling channel such considerations can be avoided.

The exemplary embodiments of this invention further permit the c-RNTIs to be allocated non-systematically from the c-RNTI address space (e.g., non-sequentially), and may allow random allocations to the UEs 10, with the constraint that the allocated c-RNTIs follow the power of two threshold currently valid and indicated by the Mask 12G.

Based on the foregoing, it can be appreciated that an aspect of the exemplary embodiments of this invention is a procedure to assign short ids to groups of UEs 10 that is achieved by the masking of the c-RNTI. In this procedure the c-RNTI module 12E of the eNB 12 assigns all UEs 10 the c-RNTI of 16 bits, (i.e., no shortened IDs are assigned). Depending on the number of UEs 10 in the cell, the c-RNTI module 12E of the eNB 12 defines a value for the Mask 12G that in turn defines the number of least significant bits (LSBs) in the c-RNTI to be used as a short id.

As one example of the c-RNTI Mask 12G:

| | |
|---|---|
| c-RNTI | x15 x14 x13 x12 x1 1 x10 x9 x8 x7 x6 x5 x4 x3 x2 x1 x0 |
| Mask | X X X X X X X 1 1 1 1 1 1 1 1 1 |

In this case the Mask 12G instructs the UEs 10 to use only the 9 LSBs (bits 0-8) of the full 16-bit c-RNTI.

The value of the Mask 12G can be selected based on:

a power of two x
μ(UE)=# UEs in LTE_Active state+handover margin+initial access margin.

After μ(UE) exceeds a high water mark (upper threshold) in the consumption of the c-RNTI address space relative to a given threshold (x), 2 exp(x), i.e., α*2exp(x), where 0<α<1.0, increase x by one.

Once μ(UE) falls under a low water mark (lower threshold) in the consumption of the c-RNTI address space relative a given threshold (x) less than the current threshold 2 exp(x−1), i.e., β*2exp(x−1), where 0≦β≦1.0, decrease x by one. Note that β and α are local parameters set to allow sensitivity to the changes of the number of UEs. β may be equal to α.

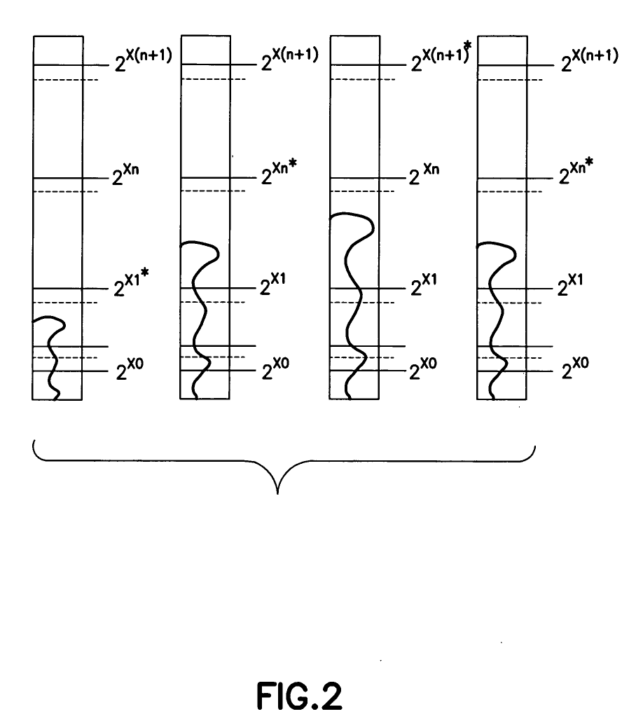

An example of c-RNTI Masking thresholds and their updates are shown in FIG. 2, where a current threshold is marked with an asterisk.

As was noted above, in a joint coding approach the c-RNTI Mask 12G can be signaled in a common part of an L1/L2 control channel as, for example, 3 bits that encodes, for example, the use of one of a set of 6, 8, 10, 12, 13, 14, 15, 16 c-RNTI bits. Alternatively, the c-RNTI Mask 12G can be signaled in the SysInfo.

As compared to some previously proposed approaches, one benefit of the use of the exemplary embodiments of this invention is that it does not require any sudden re-signalings of the allocated ids, as every c-RNTI is always fully valid, just the masking changes.

In certain situations, where there are many UEs 10 served in the cell and the Mask 12G threshold is increased, it may be the case that the Mask 12G value remains at too high a value after several UEs have left the cell, and where a certain remaining UE 10 is still assigned with a high c-RNTI. The c-RNTI of this remaining UE 10 would thus not allow changing the threshold back to a lower value. Further in accordance with the embodiments of this invention a specific RRC (or MAC) signaling message may be defined that updates (changes or re-allocates) the c-RNTI of a particular UE 10 to another c-RNTI that is available from a lower part of the c-RNTI address space. This is shown in FIG. 3A. After the c-RNTI update of this particular UE 10 is accomplished, the eNB 12 is enabled to change (reduce) the value of the Mask 12G and signal this change commonly to the UEs 10 in the cell for storage in their particular Mask 10G locations. By eliminating the higher Mask value, signaling bits are subsequently conserved over the wireless link. The RRC signaling to update the c-RNTI for this case can be expected to be used only occasionally, as typically the number of UEs 10 in a cell increases and decreases in a relatively smooth fashion as UEs 10 enter and exit the cell. Also, the process of initiating sessions causing the UEs 10 to change from the LTE_IDLE state to the LTE-ACTIVE state, and vice versa, can be expected to be smooth and balanced processes.

It can be noted that during such changes the released c-RNTIs will cause ‘holes’ in the allocated c-RNTI space, and c-RNTIs corresponding to such holes are thus available to be allocated to other UEs. Thus, the c-RNTI address space may be allocated in random order based on local knowledge of the consumption of the address space in the eNB 12.

More specifically, assume a case of different cell types: Micro cell and Macro cell. The Micro cell type is typically used in urban down-town areas, it exhibits a small ISD (<1 km), it typically has a high density of UEs 10 that can be assumed to move randomly. The Macro cell type is typically used in rural/suburban residential areas, it has a larger ISD (>=5 km), and it typically includes UEs 10 that make mainly deterministic movements with smaller random movements. The movement of UEs 10 in a cell can be modeled as a Brownian motion with means and variances depending on the cell type

Considering now the dynamic effects on the c-RNTI Mask 12G, the Brownian motion can be described with:
x=x+N(mₓ,σₓ)
y=y+N(m_{y},σ_{y})
where the movement is modeled as a normally distributed stochastic process with given means (velocity) and variances. Assume that Micro cells and Macro cells can be modeled to reflect the differing deterministic and random properties of the cells. When UEs 10 enter and leave the cell holes in the address space can arise. If the holes are small compared to the range of the address space high efficiency can still be maintained. However, if the holes grow disproportionately large compared to the c-RNTI Mask value then an inefficiency can occur

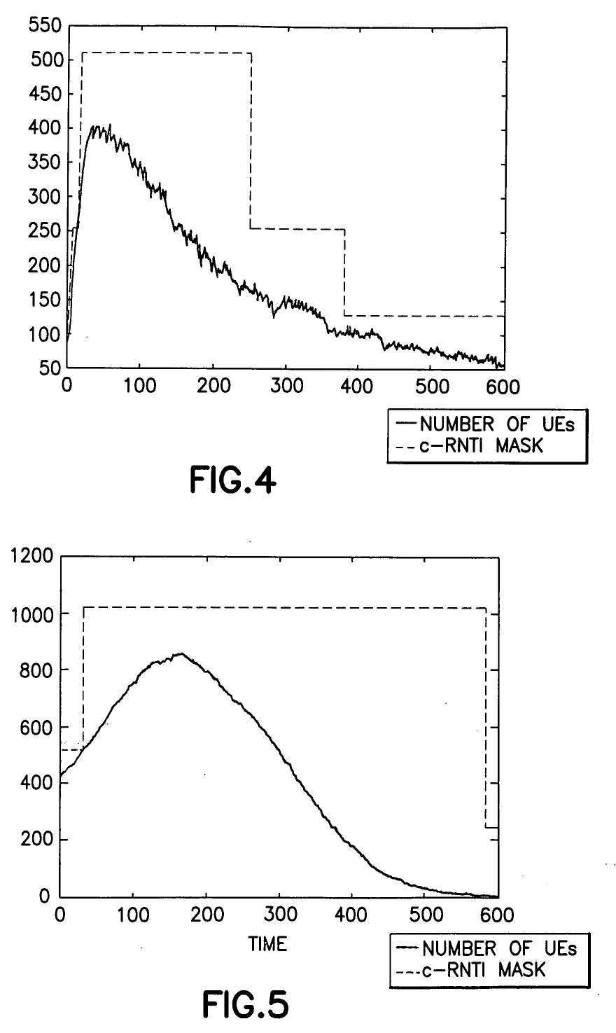

FIG. 4 shows the c-RNTI Mask behavior in the micro cell model under various load conditions (i.e., the load defined purely as the number of UEs 10 here), while FIG. 5 shows the c-RNTI Mask behavior in the Macro cell model, respectively.

As such, it can be appreciated that in certain cell types, behavior of the UEs 10 may cause holes in the c-RNTI address space and, therefore, require the use of longer words than is necessary. One solution to this is the reassignment of c-RNTIs to those UEs 10 that occupy an unnecessarily high c-RNTI number.

The c-RNTI can be signaled to the UE 10 in a secure manner by the RRC signaling.

One advantage that is gained by the use of the exemplary embodiments of this invention is signaling capacity is conserved by shortening the effective bit-fields for allocation identification. The use of the exemplary embodiments of this invention achieves this without experiencing undesirable side-effects, such as those experienced if the eNB 12 were required to group the UEs, which has timing, reliability and signaling problems.

The preferred, but non-limiting, signaling schemes include shared L1/L2 signaling and/or System Information signaling, and an addition of the Mask field to the HANDOVER_COMMAND of the RRC signaling so that the UE 10 is made aware of the Mask value in the target cell to which it will be handed over.

Certain advantages that are realized by the use of the signaling presented above may be made apparent by a review of 3GPP TSG-RAN WG1 LTE AdHoc, R1-061908, Cannes, France, 27-30 Jun. 2006, “DL L1/L2 control signaling channel performance”, Nokia.

Based on the foregoing it should be apparent that the exemplary embodiments of this invention provide a method, apparatus and computer program product(s) to reduce the signaling load between the UE 10 and the eNB 12 by defining a number of bits (m) to be used of a cell-specific UE specific identifier having n bits, where m≦n, and informing the UE of the value of m in a DL signaling message.

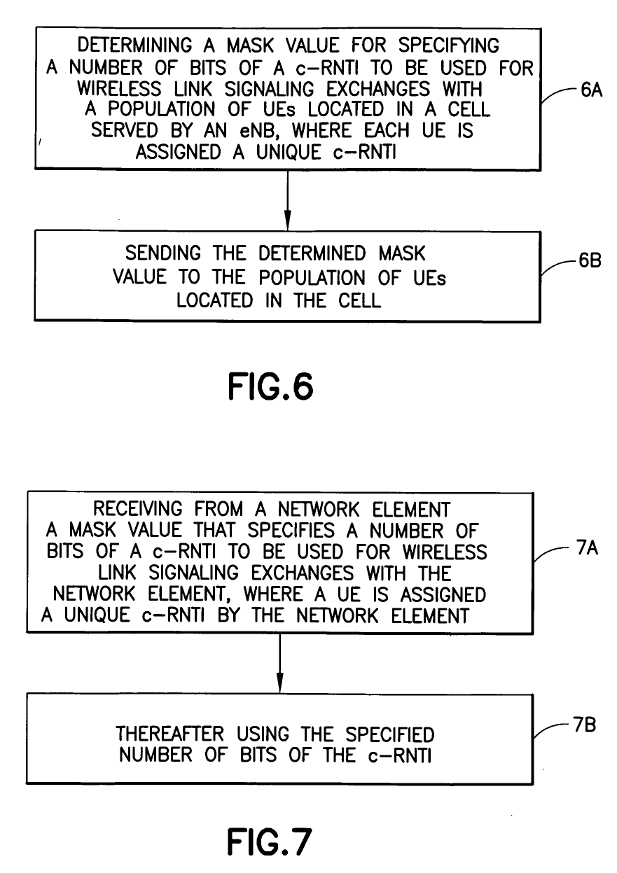

Referring to FIG. 6, in accordance with a method of operating a network element, typically the eNB 12, and in accordance with the operation of a computer program product executed at the eNB 12, there are performed operations of: determining a Mask value for specifying a number of bits of a c-RNTI to be used for wireless link signaling exchanges with a population of UEs located in a cell served by the eNB, where each UE is assigned a unique c-RNTI (Block 6A); and sending the determined Mask value to the population of UEs located in the cell (Block 6B).

In accordance with the method and computer program product of the previous paragraph, where determining considers a number of UEs currently located in the cell, and also considers a number of UEs that may enter the cell.

In accordance with the method and computer program product of the previous paragraphs, where sending the determined Mask value comprises using at least one of a shared signaling channel and a System Information message.

In accordance with the method and computer program product of the previous paragraphs, further comprising operations of determining a new Mask value for specifying the number of bits of the c-RNTI; and sending the determined new Mask value to all of the UEs located in the cell.

In accordance with the method and computer program product of the previous paragraph, where determining a new Mask value includes a preceding step of assigning at least one UE a new c-RNTI that is compatible with the new Mask value.

In accordance with the method and computer program product of the previous paragraphs, further comprising sending from an eNB of a serving cell (source eNB) to a UE to be handed over to a target cell the Mask value determined by an eNB of the target cell (target eNB), and a c-RNTI assigned to the UE by the eNB of the target cell.

In accordance with the method and computer program product of the previous paragraph, where the Mask value determined by the eNB of the target cell is sent to the UE as part of a HO command.

In accordance with the method and computer program product of the previous paragraphs, where the Mask value is sent in a message field and comprises a number of bits (p) that define a number (m) of LSB bits of the c-RNTI to be used during signaling, where the c-RNTI has n bits, and where m≦n.

In accordance with the method and computer program product of the previous paragraph, where p is equal to four or less, and where n is equal to 16.

Also disclosed herein is a network element, typically the eNB 12, that comprises a unit adapted to determine a Mask value for specifying a number of bits of a c-RNTI to be used for wireless link signaling exchanges with a population of UEs located in a cell served by the eNB, where each UE is assigned a unique c-RNTI (Block 6A); and a transmitter coupled to the unit to send the determined Mask value to the population of UEs located in the cell.

Referring to FIG. 7, further in accordance with a method of operating a UE 10, and in accordance with the operation of a computer program product executed at the UE 10, there are performed operations of: receiving from a network element a Mask value that specifies a number of bits of a c-RNTI to be used for wireless link signaling exchanges with the network element, where the UE is assigned a unique c-RNTI by the network element (Block 7A); and thereafter using the specified number of bits of the c-RNTI (Block 7B).

In accordance with the method and computer program product of the previous paragraph, where receiving the determined Mask value comprises using at least one of a shared signaling channel and a System Information message.

In accordance with the method and computer program product of the previous paragraphs, further comprising an operation of receiving a new Mask value for specifying the number of bits of the c-RNTI.

In accordance with the method and computer program product of the previous paragraph, where receiving a new Mask value includes a preliminary step of receiving a new c-RNTI that is compatible with the new Mask value.

In accordance with the method and computer program product of the previous paragraphs, further comprising receiving from an eNB of a serving cell (source eNB) in preparation for being handed over to a target cell a Mask value determined by an eNB of the target cell (target eNB), and a c-RNTI assigned to the UE by the eNB of the target cell.

In accordance with the method and computer program product of the previous paragraph, where the Mask value is received as part of a HO command.

In accordance with the method and computer program product of the previous paragraphs, where the Mask value is received in a message field and comprises a number of bits (p) that define a number (m) of LSB bits of the c-RNTI to be used during signaling, where the c-RNTI has n bits, and where m≦n.

In accordance with the method and computer program product of the previous paragraph, where p is equal to four or less, and where n is equal to 16.

Also disclosed herein is a UE 10 that comprises a receiver to receive from a network element a Mask value that specifies a number of bits of a c-RNTI to be used for wireless link signaling exchanges with the network element, where the UE is assigned a unique c-RNTI by the network element; and a unit responsive to the Mask value to thereafter use the specified number of bits of the c-RNTI.

Note that the various blocks shown in FIGS. 6 and 7 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
reducing a signaling load between a user equipment and a base station by defining for use a number of bits (m) of a cell-specific user equipment identifier that is a sequence of n bits, where m≦n; and
informing the user equipment of the value of m in a downlink message.

2. The method of claim 1, where defining comprises determining a mask value for specifying a number of bits of a c-RNTI to be used for wireless link signaling exchanges with a plurality of user equipment located in a cell served by the base station, and where informing comprises transmitting the determined mask value to the plurality of user equipment located in the cell.

3. The method of claim 2, where determining considers a number of user equipment currently located in the cell, and also considers a number of user equipment that may enter the cell.

4. The method of claim 2, where transmitting the determined mask value comprises using at least one of a shared signaling channel and a system information message.

5. The method of claim 2, further comprising determining a new mask value for specifying the number of bits of the c-RNTI to be used for wireless link signaling exchanges; and sending the determined new mask value to the plurality of user equipment located in the cell.

6. The method of claim 5, where determining the new mask value includes a preceding step of assigning at least one user equipment a new c-RNTI that is compatible with the new mask value.

7. The method of claim 2, further comprising transmitting from a base station of a serving cell to a user equipment to be handed over to a target cell a mask value determined by a base station of the target cell, and a c-RNTI assigned to the user equipment by the base station of the target cell.

8. The method of claim 7, where the mask value determined by the base station of the target cell is transmitted to the user equipment as part of a handover command.

9. The method of claim 2, where the mask value is transmitted in a message field and comprises a number of bits (p) that defines (m) as the number of least significant bits of the c-RNTI to be used during signaling, where the c-RNTI has n bits.

10. The method of claim 9, where p is equal to four or less, and where n is equal to 16.

11. The method of claim 2, performed as a result of the execution of computer program instructions by a data processor of the base station.

12. An apparatus, comprising:
a wireless transmitter configurable to conduct communications with a plurality of user equipment located in a cell; and
a user equipment identification module configurable to define a number of bits (m) of a cell-specific user equipment identifier that is a sequence of n bits, where m≦n, and to inform the user equipment of the value of m in a downlink message via said transmitter.

13. The apparatus of claim 12, said user equipment identification module operable to determine a mask value to specify a number of bits of a c-RNTI to be used for wireless link signaling exchanges, where each user equipment is assigned a unique c-RNTI, and to transmit the determined mask value to the plurality of user equipment.

14. The apparatus of claim 13, said user equipment identification module operable to consider a number of user equipment currently located in the cell and to also consider a number of user equipment that may enter the cell.

15. The apparatus of claim 13, said user equipment identification module informing the plurality of user equipment using said transmitter of the determined mask value via at least one of a shared signaling channel and a system information message.

16. The apparatus of claim 13, said user equipment identification module further configurable to determine and send a new mask value for specifying the number of bits of the c-RNTI to be used for wireless link signaling exchanges.

17. The apparatus of claim 13, when embodied in a source base station, sending via said transmitter as part of a handover message a target cell-determined mask value and c-RNTI assigned to the user equipment in the target cell.

18. The apparatus of claim 13, where the mask value comprises a number of bits (p) that defines (m) as the number of least significant bits of the c-RNTI to be used, where the c-RNTI has n bits.

19. The apparatus of claim 18, where p is equal to four or less, and where n is equal to 16.

20. A method, comprising:
receiving from a network element a c-RNTI value and a mask value that specifies a number of bits of the c-RNTI to be used for wireless link signaling exchanges with the network element; and
using only the specified number of bits of the c-RNTI in subsequent signaling exchanges.

21. The method of claim 20, where the mask value is received through at least one of a shared signaling channel and a System Information message.

22. The method of claim 20, further comprising receiving a new c-RNTI that is compatible with a new mask value.

23. The method of claim 20, further comprising receiving from a serving cell network element, prior to being handed over to a target cell, a mask value and a c-RNTI determined for use in the target cell.

24. An apparatus, comprising:
a receiver configurable to receive from a network element a mask value that specifies a number of bits of a c-RNTI to be used for wireless link signaling exchanges with the network element; and
a unit responsive to the mask value to thereafter use only the specified number of bits of the c-RNTI.

25. The apparatus of claim 24, embodied in a user equipment configurable for operation with an evolved Node-B.
